(19) United States
(12) Patent Application Publication
(10) Pub. No.: US 2018/0277857 A1
(43) Pub. Date: Sep. 27, 2018

(54) METHOD OF MANUFACTURING A SPONGY NICKEL CATALYST AND SPONGY NICKEL CATALYST MADE THEREBY

(71) Applicant: Apollo Energy Systems, Inc., Pompano Beach, FL (US)

(72) Inventors: Robert R. ARONSSON, Pompano Beach, FL (US); Peter KALAL, Pompano Beach, FL (US); Barry ISEARD, Pompano Beach, FL (US); Viktor HACKER, Graz (AT); Alexander SCHENK, Graz (AT); Alexandra MUELLER, Graz (AT)

(21) Appl. No.: 15/464,970

(22) Filed: Mar. 21, 2017

(51) Int. Cl. H01M 4/98; H01M 4/90; H01M 4/88; H01M 8/083; B22D 23/06; B22D 29/00

(52) U.S. Cl. CPC H01M 4/98; H01M 4/9041; H01M 4/8875; H01M 2300/0014; B22D 23/06; B22D 29/002; H01M 8/083

(57) ABSTRACT

A method includes of manufacturing a nickel alloy includes providing nickel alloy components in powdered form and in a selected ratio and melting the nickel alloy components using an electron beam, using selected parameters, to generate a spongy metal catalyst precursor alloy material.

### BACKGROUND OF THE INVENTION

Spongy, or Raney, nickel is a fine-grained solid composed mostly of nickel derived from a nickel-aluminum alloy that is available in a variety of grades. Some are pyrophoric, most are used as air-stable slurries. Spongy nickel is used as a reagent and as a catalyst in organic chemistry. The generic terms “skeletal catalyst” or “sponge-metal catalyst” may be used to refer to catalysts of this type.

One application of a spongy nickel catalyst is for the anodes of an alkaline fuel cell. The alkaline fuel cell (AFC) has been used since the mid-1960s, for example in Apollo-series missions and on the Space Shuttle, Alkaline fuel cells consume hydrogen and pure oxygen producing potable water, heat, and electricity. They are among the most efficient fuel cells, having the potential to reach 70% efficiency.

The ongoing commercialization of fuel cells is taking place in the international well established field of acidic polymer electrolyte membrane fuel cells (PEFCs), however these fuel cells in common with most types of low temperature fuel cells use precious metal or platinum-group metals as a catalyst.

The electrochemical reactions of H2/O2 alkaline fuel cells are as follows:

2H₂+4OH⁻→4H₂O+4e⁻ Anode reaction:

O₂+4e⁻+2H₂O→4OH⁻ Cathode reaction:

2H₂+O₂→2H₂O Overall reaction:

Typically, in AFCs an aqueous potassium hydroxide solution is used as electrolyte. Hydroxide anions (OH—) are formed at the cathode from oxygen and water, consuming 4 electrons per molecule of oxygen. The hydroxide ions migrate from the cathode to anode of the fuel cell and are there converted to water, consuming hydrogen and releasing two electrons per molecule of hydrogen. The electrons flow through the external load and are consumed in the cathode half-cell reaction.

### SUMMARY AND OBJECTS OF THE INVENTION

In an embodiment, a method of manufacturing a nickel alloy includes providing nickel alloy components in powdered form and in a selected ratio and melting the nickel alloy components using an electron beam, using selected parameters, to generate a spongy metal catalyst precursor alloy material.

In an embodiment, a fuel cell includes at least one component comprising a spongy metal alloy made by the foregoing method.

In an embodiment, an anode for use in an alkaline fuel cell includes at least one electrode component comprising a spongy metal alloy made by the foregoing method.

### BRIEF DESCRIPTION OF THE DRAWINGS

The invention may be better understood with reference to the drawings:

FIG. 1 is a Nickel-Aluminum phase diagram illustrating the phase structure of the nickel aluminum alloy system;

FIG. 2 schematically illustrates the electron beam welding apparatus;

FIG. 3 schematically illustrates the formation of a weld cavity and the progress of the beam through the workpiece;

FIG. 4 illustrates schematically the forces acting on the liquid surface at the bottom of the weld cavity;

FIG. 5 illustrates schematically an isometric view of the progressing weld as the beam moves through the workpiece;

FIG. 6 illustrates schematically steps in a process for producing a metal alloy nugget in accordance with an embodiment;

FIGS. 7a-7f are micrographs illustrating progress of the formation of a metal nugget in accordance with an embodiment, where FIG. 7a-7c represent a first second of melting, FIG. 7d represents the melting of the precursor metal powders along the spiral electron beam, FIG. 7e represents the enlargement of the melt zone toward a single sphere of molten material which is depicted in FIG. 7f;

FIG. 8a is a micrograph of a front of a nugget formed in accordance with an embodiment and FIG. 8b is a micrograph of the back of the nugget of FIG. 8a;

FIGS. 9a-9d are micrographs of different sections of the Ni—Al alloy illustrating: (a) homogeneous distribution of Ni and Al, (b) high porosity in the surface zone (c) microstructure at higher magnification, and (d) three different visible phases;

FIG. 10a is an electron micrograph and FIGS. 10b-10d are energy dispersive X-Ray (EDX) scans of three different spots from FIG. 10a;

FIGS. 11a-11f illustrate results of melting ingots at different frequencies;

FIGS. 12a-12f illustrate shows results of melting ingots at different beam currents;

FIGS. 13a-13f illustrate stages of melting of an Ni—Al—Fe—Cr ingot at different times;

FIG. 14a is a micrograph of a front of a nugget formed in accordance with an embodiment and FIG. 14b is a micrograph of the back of the nugget of FIG. 14a;

FIG. 15a is an EDX image illustrating distribution of Ni—Al—Fe—Cr, while FIGS. 15b-15e are elemental maps showing nickel distribution, aluminum distribution, iron distribution, and chromium distribution, respectively, and FIG. 15f is a combined elemental map;

FIG. 16 shows the current-potential characteristic of the spongy nickel anode according to an embodiment;

FIG. 17 shows the current density during long-term testing at 40 mV anode potential;

FIG. 18 shows the current-potential characteristic of the spongy nickel anode according to an embodiment; and

FIG. 19 shows the current-voltage characteristic of the tested alkaline fuel cell.

### DETAILED DESCRIPTION OF THE INVENTION

New developments in the field of alkaline fuel cells (AFCs), as exemplified by embodiments described herein, use non-platinum group metals and certain metal oxides such as perovskites and spinels, for example, for the anode and cathode catalyst. The alkaline environment enables the use of a broad range of less noble and certainly more cost-saving materials than platinum, which is state-of-the-art in acidic cells.

One such non-platinum material is spongy nickel.

Generally, there are three different methods employed to produce spongy Ni:

Gas atomization: For this method, aluminum in molten state is flame-sprayed on porous spongy nickel-sheets. Afterwards, the plates are heated to initiate the formation of the Ni—Al alloy. To activate the catalyst, the aluminum is leached off the metal sheet.

Mechanical alloying (MA): MA is used to manufacture alloys with metastable phases. Therefore, the powder mixtures are processed by a ball mill at room temperature and under argon gas flow. Afterwards the aluminum is leached out with a sodium hydroxide solution. One main advantage of the MA method is the reduced particle size, thus the higher surface area of the obtained alloy.

Melting: The alloy is manufactured by dissolving nickel in molten aluminum in a crucible followed by a quenching step. During quenching, different phases appear. Thus, the initial composition is inhomogeneous. The obtained phases react differently to the leaching process and therefore influence the porosity of the resulting material to a very high degree. The resulting metal is then ground to a powder with the desired particle size and leached in highly concentrated sodium or potassium hydroxide solution.

When the nickel alloy spongy nickel precursor is prepared by any of the foregoing methods it must be activated for use. By treating the aluminum-nickel alloy in an alkaline solution, the aluminum is leached out of the alloy forming a porous nickel structure. The remaining spongy nickel can then be used as a catalyst for hydrogenation, mainly of unsaturated organic compounds; however it can also be used as anode catalyst in AFCs.

During leaching with sodium hydroxide solution (NaOH, or alternately KOH), the following reaction takes place:

$$Al + NaOH + 3 {H}_{2} O \to {NaAl ( OH )}_{4} + \frac{3}{2} {H}_{2}$$

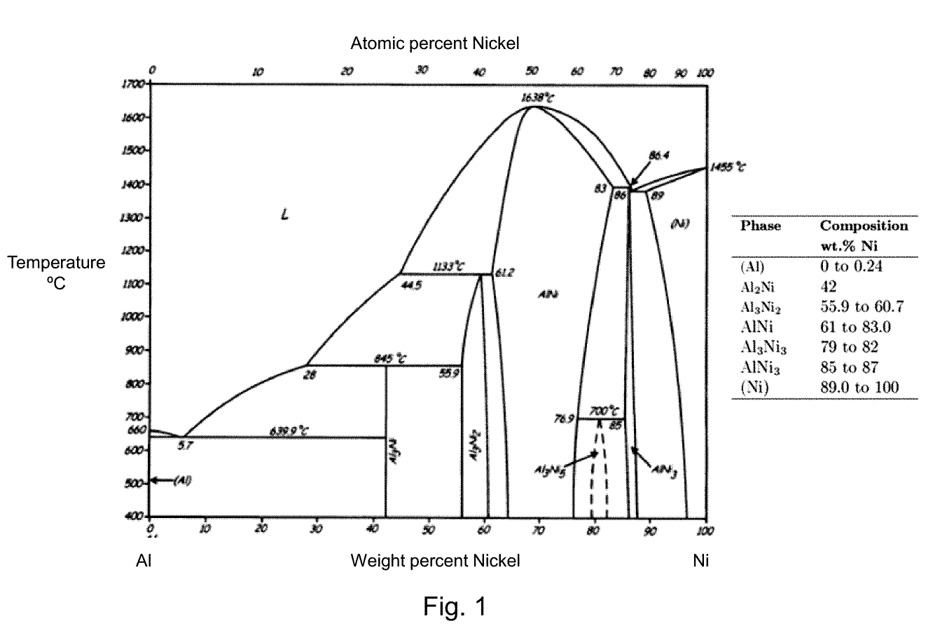

At the beginning aluminum is leached out of the eutectic as shown in FIG. 1, followed by the removal of aluminum from the intermetallic phases. It can be assumed that the phases undergo these transformation steps:

NiAl₃→Ni₂Al₃→NiAl→Ni₃Al→Ni

According to these steps, the attack starts at the phase with the highest Al concentration. However, the Ni3Al—Al-alloy is transformed directly into Ni.

During the leaching process, hydrogen is stored in the sponge, partly adsorbed at the surface and also dissolved into defects of the nickel lattice. The reversibly stored hydrogen is responsible for the catalytic activity. Therefore, the skeletal Ni is highly pyrophoric and thus it has to be handled under inert atmosphere; or deactivated in order to be used as a catalyst for electrode preparation and reactivated when immersed in the electrolyte.

High energy electron beams have been used mainly for welding purposes. “Electron Beam Welding” and the technology have been developed for the joining of metals which are difficult to weld using conventional techniques, e.g. titanium.

Electron Beam Melting (EBM) is a melting technique, using the same principals as electron beam welding, where highly accelerated and focused electrons are directed onto the surface of a workpiece, e.g. a crucible containing metal powder, using magnetic fields. When the electrons hit the sample, they decelerate and the kinetic energy is converted into thermal energy. The targeted material starts to melt and the alloy is formed after cooling. These melting processes are generally performed under high vacuum, in order to prevent the electron beam from being affected by atmospheric constituents (for example, deflection by air molecules, attenuation, diffraction, etc.). In an embodiment, the application of vacuum for the beam means that it is possible to perform the melting without using a shielding gas.

EBM systems may be used to fuse dissimilar materials, in part due to the high energy density of the electron beam. Thus, even metals with particularly diverse melting points and thermal conductivities may be fused successfully using this method, which may result in more homogeneous alloys than obtainable with alternate methods, EBM may also provide fast processing times and good process control, which may allow for optimization based on a specific desired resulting alloy.

The quality of components produced with EBM depends on the process parameters, as well as the material and its properties. Especially when melting powders, the energy source and the material composition may influence the microstructure of the resulting component. Generally, the beam parameters determine the penetration depth and the weld pool geometry and consequently, the melting and solidification processes. Among others, the following main beam parameters can usually be regulated: beam current, acceleration voltage, focus point, spot velocity and beam pattern. Furthermore, the employed beam pattern can influence the homogeneous distribution of heat within the targeted material. If the process parameters are not adjusted accurately, negative effects such as the splattering of powder particles can occur due to electrostatic charging of material grains.

The activity of spongy nickel as an anode catalyst in alkaline fuel cells may be enhanced by alloying with small amounts of other metals “dopants” such as chromium. In an embodiment, the present methods may make use of Electron Beam Melting (EBM) to produce a homogeneous nickel aluminum alloy with controlled amounts of dopants.

In an embodiment, EBM may be used to fuse dissimilar metals to form the desired nickel-aluminum alloy, as a precursor for the various applications described herein.

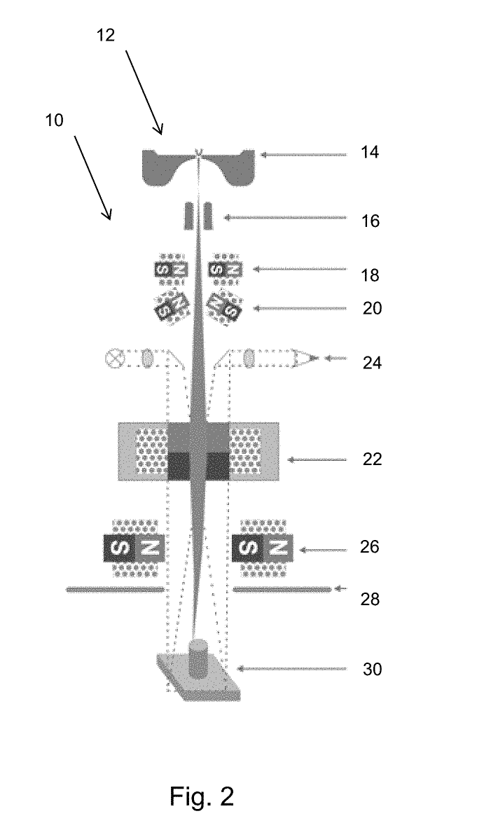

The general principal of operation of electron beam melting is shown with reference to FIG. 2. An EBM system 10 includes a beam source 12 which is operated to generate a narrow beam with variable power. Inside the beam source, a cathodic material 14 (e.g., a tungsten wire) is heated electrically to enable emission of electrons. By applying a bias voltage, which may be typically in the range of 60-150 kV, the electrons are accelerated towards an annular anode 16. Through the hole in the anode, the electrons can be directed towards the workpiece and are guided/shaped by a centering coil 18, a stigmator 20 and a lens 22. A light/optical viewing system 24 may be provided to allow an operator to observe the process. A deflector 26 may be used to position the beam and an electron optical viewing system 28 may likewise be used for process observation. The beam is directed by the deflector 26 onto the workpiece 30 to perform the desired melting.

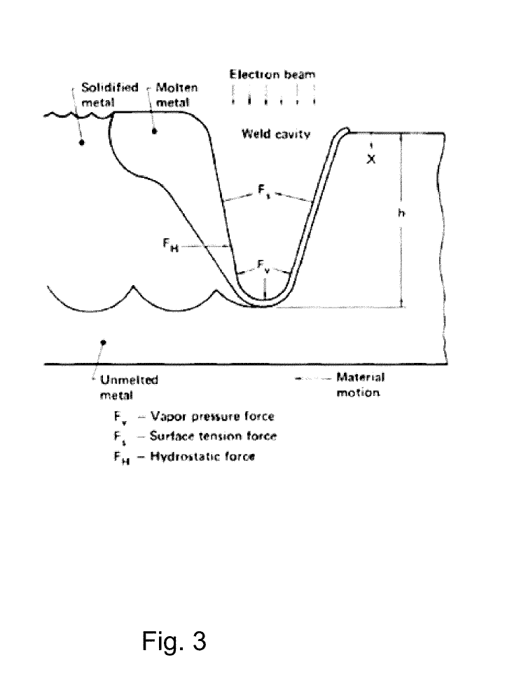

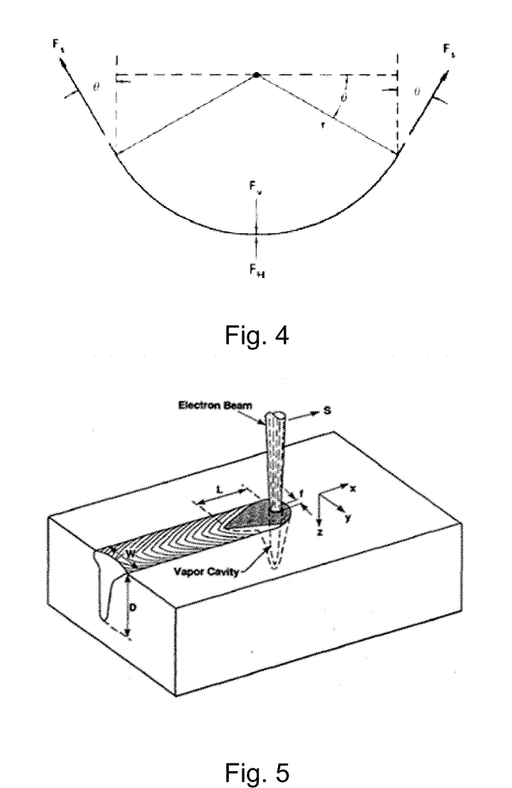

While electrons typically have a low penetration depth into metallic materials, achievable welding depths can be several centimeters. The high-energy electrons melt and even vaporize the material forming a capillary. This so-called keyhole facilitates further penetration of the beam into the target material. As noted above, the process is generally performed under high vacuum (<10⁻⁴ Pa) to avoid beam attenuation. Nearly all materials that are electrically conductive can be welded in this manner, and a wide range of material thicknesses can be fused. An example of the geometry of a weld is illustrated schematically in FIGS. 3-5.

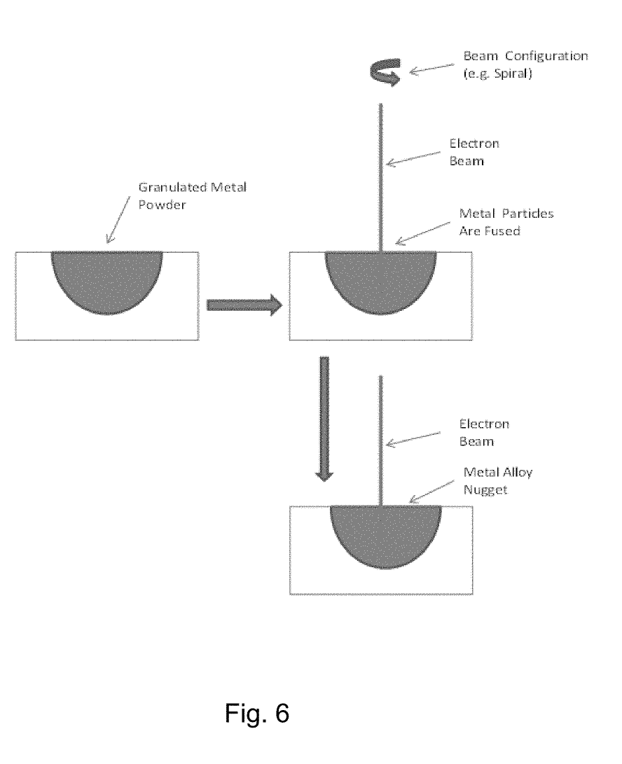

The schematic operating principle of EBM is shown in FIG. 6. After one layer is finished, the stage moves downwards, more powder is added and again melted locally. Each layer is built up according the given 3D-model. Repeating this process over and over again, the desired geometry can be produced step by step. These melting processes have to be performed under high vacuum, as discussed above. The quality of components produced with EBM depends on the process parameters, as well as the material and its properties. Especially when melting powders or liquids, the energy source and the material composition may have a large influence on the resulting composition. The beam parameters generally determine the penetration depth and the weld pool geometry and consequently, the melting and solidification processes. Among others, the following main beam parameters can usually be regulated: beam current, acceleration voltage, focus point, spot velocity and beam pattern. If the process parameters are not adjusted accurately, negative effects such as the splattering of powder particles can occur, due to electrostatic charging of material grains. A high electrical resistance is build-up at the contact points of the particles, hindering the discharge of the charge carrier. Subsequently, an electrostatic charge remains, initiating repulsion between two equally charged particles. Assuming the powder particles are globular, the electrical charge Q_{g} is calculated using the following equation 1:

Q_{g}=ηIt (1)
Q_{g} . . . Charge [C],
I . . . Current [A],
t . . . Time [s],
η . . . Part of electrons remaining on the grain (ca, 1%)

Using Coulomb's law (Equation 2) the repulsive force of two equal sized and charged grains can be determined:

$${F}_{rep} = \frac{1}{4 {πϵ}_{0}} \cdot \frac{{Q}_{ℊ}^{2}}{{d}_{ℊ}^{2}} \qquad ( 2 )$$

Where:
Fᵣₑₚ . . . Repulsive force [N],
Q_{g} . . . Charge [C],
d_{g} . . . Distance between the charges [m],
ε₀=8.854. 10⁻¹² . . . Dielectric constant [F·m⁻¹]

Apart from electrostatic charging, mechanical, electrodynamic and thermodynamic effects contribute to the splattering of particles. However, these effects are usually insignificant.

Thermodynamics of the Melting Process:

Heating a solid material to a certain temperature requires a specific energy, depending on the material's properties. This can be estimated using the following formula:

$$Δ {G}_{sl} = \frac{{H}_{f} Δ T}{{T}_{f}} - {\int }_{{T}_{0}}^{{T}_{f}} Δ {c}_{p} ( T ) dT + T {\int }_{{T}_{m}}^{T} \frac{Δ {c}_{p} ( T )}{T} dT \qquad ( 3 )$$

Where:
ΔGₛₗ . . . Gibbs free energy for phase transformation from solid to liquid [J]
T₀ . . . Starting temperature [K]
T_{f} . . . Temperature of phase transformation (fusion) [K]
H_{f} . . . Heat of fusion [J·kg⁻¹]
Δcₚ, . . . Heat capacity of liquid and solid state [J·kg⁻¹·K⁻¹]

According to Equation 3, the energy demand depends on the properties of the liquid, as well as of the solid state of the material. The energy demand may be used then to estimate the beam parameters.

In one example, the targeted alloy was formed out of powdery starting materials within a few seconds, possessing a highly homogeneous distribution of the metals, of composition 48 wt. % Ni, 48 wt. % Al, 2 wt. % Fe and 2 wt. % Cr, using electron beam melting (EBM). This formed metal alloy has been subjected to the leaching, deactivation, activation and fabrication as an as active anode catalyst material with defined properties and compositions for use as an anode catalyst in an alkaline fuel cell.

### Example 1

Fabrication of Spongy Nickel Using EBM:

Nickel-Aluminum Alloy:

Aluminum and nickel powder were mixed in a wt. %-ratio of 50:50 and placed into a stainless steel crucible. The Nickel/aluminum phase diagram is shown in FIG. 1. The metal powder mixture was then fused in the EBM apparatus using the following processing parameters:

TABLE 1
Processing parameters

| UA/kV | IB/mA | t/s | f/Hz | Figure |
|---|---|---|---|---|
| 120 | 3.00 | 40 | 500 | Spiral10000 |

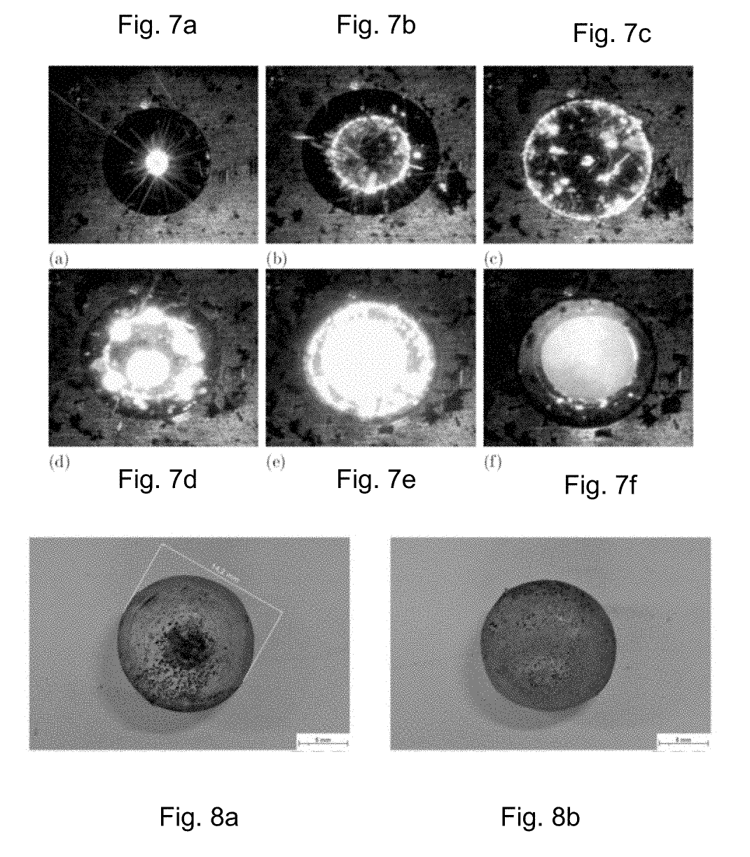

The fusion and solidification are displayed step by step in FIGS. 7a-7f. During the process the different powder grains melt, forming a spheroidal structure due to surface tension. The nugget is generally formed within 6-8 s. The remaining processing can be considered as a heat treatment, where the elements of the alloy distribute evenly throughout the sample. According to FIG. 1 the phases Al3Ni (Tm=854° C.) and Al3Ni2 (Tm=1133° C.) mainly build up at this composition. After formation of the alloy nugget, it is not re-melted by the electron beam with the same energy due to the higher average melting point of the nugget alloy. The melting procedure may be repeated for further homogenization of the alloy. The resulting alloy nugget (FIG. 8) was cut in half and further investigated using electron microscopy.

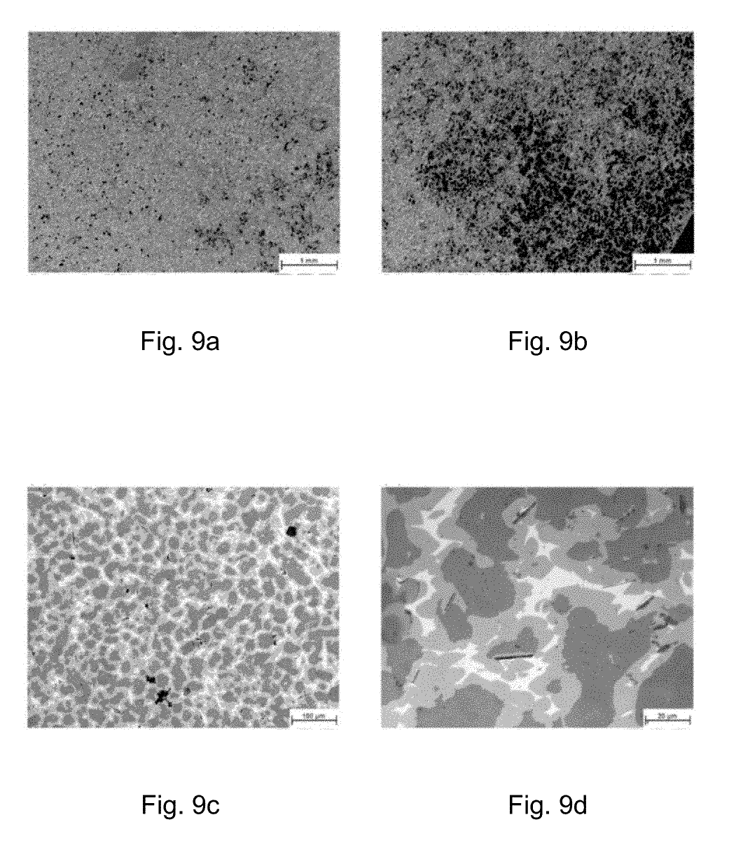

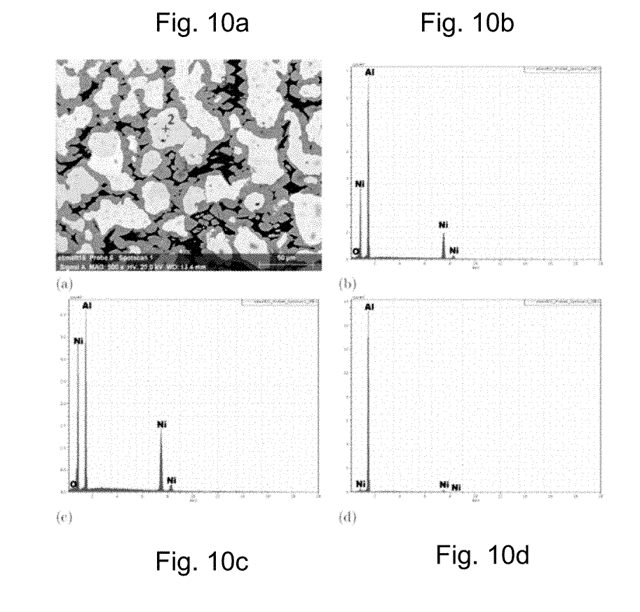

The microstructure is quite homogeneous as illustrated in FIG. 9a, while FIG. 9b shows that porosity is high, particularly near the surface of the nugget. FIG. 9c shows the same microstructure at a higher magnification and the even higher magnification of FIG. 9d shows three visible phases. The same composition was subjected to EDX analysis as shown in FIGS. 10a-10d. Starting with a backscattered electron image (FIG. 10a), three scan spots were selected and the composition is shown in FIGS. 10b-10d corresponding to spots 1, 2, 3 in FIG. 10a.

Spot-scan 1 shows a Ni to Al ratio of 50/50. In spot-scan 2 the Ni fraction is slightly elevated at the expense of Al. However, in spot-scan 3 the detected amount of Ni is close to the detection limit, thus not allowing an estimation of phase composition.

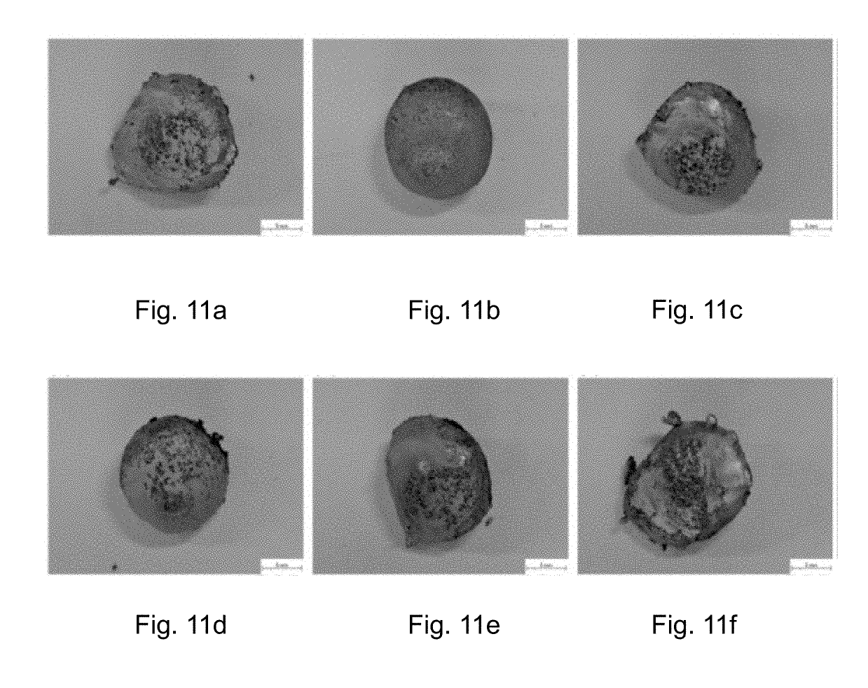

To investigate the influence of the diverse melting parameters, further experiments were performed with Al and Ni powder, using different frequencies. Previous tests showed that f=500 Hz (FIG. 11b) is sufficient. However, the following frequencies were additionally tested: 50 Hz (FIG. 11a), 1,000 Hz (FIG. 11c), 2,000 Hz (FIG. 11d), 3,000 Hz (FIG. 11e) and 5,000 Hz (FIG. 11f).

By changing the frequency from 50 Hz to 500 Hz the result improves. A further elevation of the beam frequency to 1,000 Hz and especially to 2,000 Hz results in nuggets that are macroscopically more uniform. Above a frequency of 3,000 Hz there is no apparent further improvement. The nugget melted using 5,000 Hz shows a completely irregular shape. Note that the nugget in FIG. 11b fused with 500 Hz was melted twice, thus it cannot be compared directly to the other results.

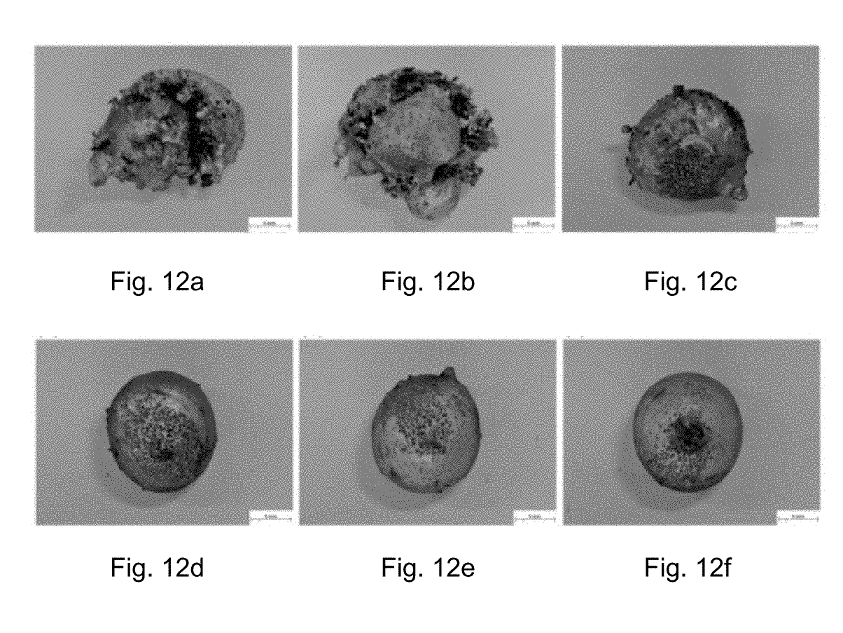

Subsequently, another experimental series was carried out to investigate the influence of different beam currents. The tests were started with a current of 1.8 mA (FIG. 12a) and then increased stepwise by 0.2 mA (FIGS. 12b-12e, ranging from 2.0 mA to 2.6 mA). Previous tests already used a current of 2.8 mA, thus it was not repeated and FIG. 12f represents a 3.0 mA current.

The melting processes using 1.8 mA and 2.0 mA resulted in misshaped nuggets, as a spheroidal shape is hardly visible. It can be assumed that at this low current the energy input was not high enough. An improvement concerning the shape was obtained by increasing the current to 2.2 mA. With a beam current of 2.4 mA and 2.6 mA further a more uniform shape of the nuggets is recognizable. From a macroscopic point, a current of 3.0 mA gave the best results after one melting step. The alloy nugget had a clearly round shape and smooth surface compared to the nuggets melted with lower currents.

### Example 2

Nickel-Aluminum Alloy Including Iron and Chromium Dopants:

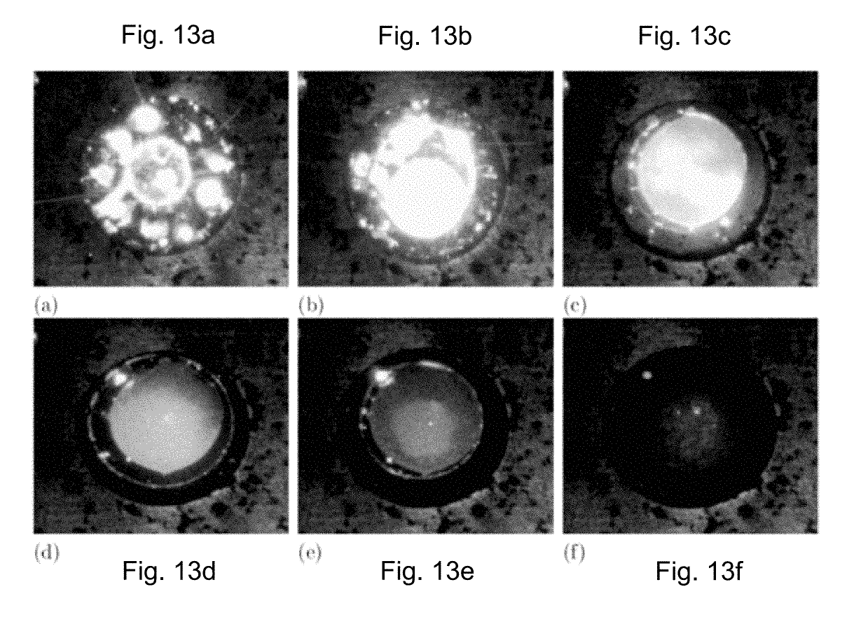

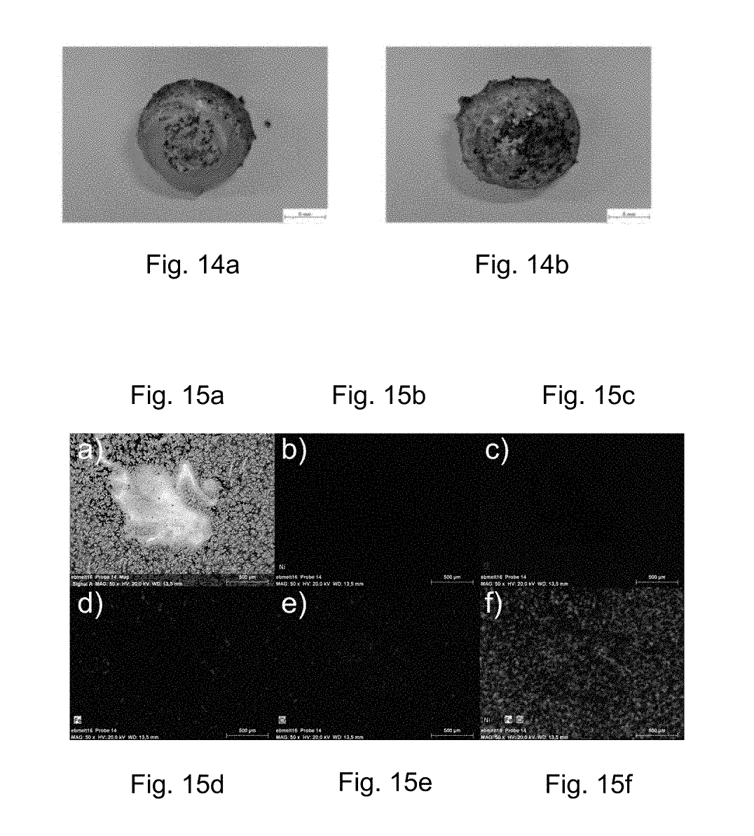

After initial optimization of the processing parameters, dopants were added to the nickel-aluminum mixture. The melting process is imaged step by step in FIGS. 13a-13f, representing 1s, 3s, 5s, 7s, 10s, and 20s, respectively. The processing parameters are given in TABLE 2. The resulting nugget is shown in FIGS. 14a (front) and 14b (back),

TABLE 2
Processing parameters

| UA/kV | IB/mA | t/s | f/Hz | Figure |
|---|---|---|---|---|
| 120 | 3.00 | 40 | 1,000 | Spiral10000 |

Elemental mapping revealed a homogeneous distribution of all 4 metals in the alloy as shown in FIGS. 15a-15f, where FIG. 15a is the BSE image, FIG. 15b represents Nickel, FIG. 15c represents Al, FIG. 15d represents Fe, FIG. 15e represents Cr and FIG. 15f is a greyscale image generated from a color image including all four elements.

The resulting alloy (Ni—Al—Fe—Cr) was further treated for investigating the catalytic activity in alkaline fuel cells.

Briefly, the process includes grinding of base material, weighing and mixing of powders in the crucible, melting of powders using EBM, crushing of the manufactured alloy, milling to fine powder, leaching of the alloy powder in hydroxide solution, surface passivation of the pyrophoric Ni sponge, electrode manufacturing, re-activation of the Ni sponge inside the electrodes, and resulting in a catalytically active electrode.

After grinding and leaching of the alloy nugget, the obtained spongy nickel was subjected to surface passivation and mixed with carbon material and PTFE to give the electrode dough. An aliquot of the dough was used to manufacture fuel cell electrodes following a cross-rolling procedure.

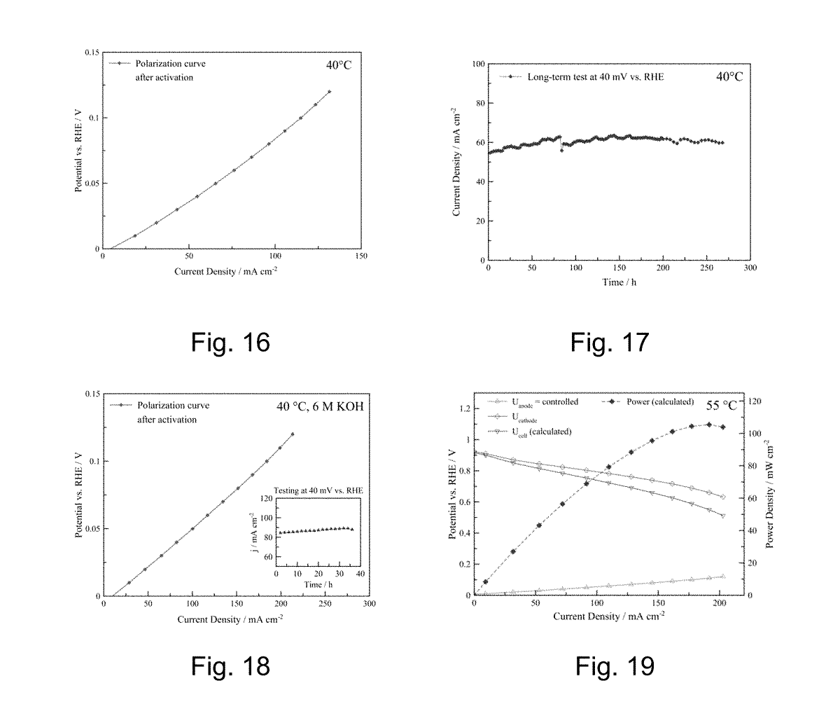

The catalytic activity of the obtained spongy nickel was investigated by placing the respective fuel cell electrode in a standard 3-electrode half-cell configuration and a fuel cell setup respectively. For the half-cell measurements the spongy Ni electrode was the working electrode. The counter electrode consisted of stainless steel and a reversible hydrogen electrode was used as reference electrode. The electrolyte was 6M potassium hydroxide. For the fuel cell measurements a La_{0.65}Sr_{0.35}MnO₃ catalyzed cathode was used for the oxygen reduction reaction. For fuel cell measurements, the anode potential was controlled, whereas the cathode potential was monitored for calculating the overall cell voltage and the power density. Results of the testing are shown in FIGS. 16-19.

The current-voltage characteristics of the tested anodes using the spongy nickel catalyst from EBM as well as the long-term measurements and fuel cell measurements revealed high activity, hence a good performance of the electrodes within alkaline fuel cells.

Though the foregoing specification has focused on Ni—Al alloy, it is contemplated that the principles described may apply to alloys containing various metals, for example Ni, Al, Fe, Co, Ti & Mo, produced by electron beam melting as a precursor for fabricating all kinds of sponge nickel catalysts for use as hydrogenation and other chemical reaction catalysts, and for anode catalyst in alkaline fuel cells, for example.

The description of the present application has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

The descriptions above are intended to be illustrative, not limiting. Thus, it will be apparent to one skilled in the art that modifications may be made as described without departing from the scope of the claims set out below.

1. A method of making a nickel alloy comprising:
providing nickel alloy components in powdered form and in a selected ratio;
melting the nickel alloy components using an electron beam, using selected parameters, to generate a spongy metal catalyst precursor alloy material.

2. A method according to claim 1, wherein the selected parameters include one or more parameters selected from the group consisting of: beam current, acceleration voltage, beam frequency, focus point, spot velocity and beam pattern.

3. A method as in claim 2, wherein the parameters are varied to alter a characteristic of the nickel alloy material.

4. A method as in claim 3, wherein the frequency of the electron beam is selected to improve uniformity of the alloy.

5. A method as in claim 3, wherein the electron beam current is selected to improve uniformity of the alloy.

6. A method as in claim 1, wherein the alloy components comprise nickel and aluminum.

7. A method as in claim 6, wherein the alloy components further comprise iron and/or chromium as dopants.

8. A method as in claim 1, further comprising further melting using an electron beam to increase a homogeneity of the precursor alloy material.

9. A method as in claim 8, wherein the further melting uses different selected parameters from the selected parameters of the melting.

10. A method of manufacturing a nickel catalyst comprising processing the precursor alloy material of claim 1 to produce a nickel catalyst.

11. A method as in claim 10, wherein the processing comprises activating the precursor alloy material by treating it in an alkaline solution to form a porous nickel structure.

12. An anode made by the process of claim 1.

13. A fuel cell comprising an anode made by the process of claim 1.

14. A method of manufacturing an electrode comprising:
combining powdered alloy components in a crucible;
melting the combined powders using an electron beam to produce an alloy material;
milling the alloy material to produce an alloy powder;
processing the alloy powder with a basic solution to produce a pyrophoric nickel sponge;
performing surface passivation of the pyrophoric nickel sponge;
forming the nickel sponge into an electrode; and
reactivating the nickel sponge.

15. A method of making an alloy comprising:
providing metallic alloy components in powdered form and in a selected ratio;
melting the metallic alloy components using an electron beam, using selected parameters, to generate a spongy metal catalyst precursor alloy material.

16. A method as in claim 15, wherein the alloy comprises one or more metals from the group consisting of: Ni, Al, Fe, Co, Ti, and Mo.

17. A precursor alloy material manufactured by a method comprising:
combining powdered alloy components in a crucible;
melting the combined powders using an electron beam to produce an alloy material;
milling the alloy material to produce an alloy powder;
